(19) United States
(12) Patent Application Publication
(10) Pub. No.: US 2018/0152407 A1
(43) Pub. Date: May 31, 2018

(54) TASK DELEGATION MANAGER AND INTERFACE

(71) Applicant: Microsoft Technology Licensing, LLC, Redmond, WA (US)

(72) Inventor: Shahil Soni, Seattle, WA (US)

(73) Assignee: Microsoft Technology Licensing, LLC, Redmond, WA (US)

(21) Appl. No.: 15/364,545

(22) Filed: Nov. 30, 2016

(51) Int. Cl. H04L 12/58

(52) U.S. Cl. CPC H04L 51/18; H04L 51/34; H04L 51/04

(57) ABSTRACT

Systems and methods for tracking the progress and completion of delegated tasks. A delegated task is a task that has been assigned to a responsible person for completion by a delegator or manager. Traditionally, such delegated tasks are not tracked within the manager's calendar/tasking application and, accordingly, the manager may find it difficult to track the progress of delegated tasks. Moreover, it is commonplace for a delegator to assign a task via a message or other informal means of communication. Not only so, but while the delegated task is pending, the delegator and the responsible person may interact regarding the progress of the delegated task using a variety of different message types (e.g., email, text, instant messaging, voice mail, in-person communications, phone calls, etc.). The methods and systems herein provide a management tool in a centralized location for easily tracking the progress and completion of a plurality of delegated tasks.

### BACKGROUND

Today, people collaborate using a variety of communication types, including texts, instant messages, emails, message boards, etc. When collaborating on a project or other activity, it has become commonplace for someone to delegate a task to another person via one of these forms of communication. However, in this case, it is difficult to track the progress and completion of such delegated task. For instance, a sales manager may request that a sales associate follow up with a new contact via an instant message (“IM”). The sales associate may accept the task assignment via a reply IM, but may provide details regarding the follow up in a subsequent email. Alternatively, as the task assignment was communicated via IM, the sales associate may forget to perform the task altogether. In this case, the sales manager is required to remember both the task and to whom it was delegated in order to follow up on task progress and completion.

It is with respect to these and other general considerations that embodiments have been described. Also, although relatively specific problems have been discussed, it should be understood that the embodiments should not be limited to solving the specific problems identified in the background.

### SUMMARY

The disclosure generally relates to a system and methods for tracking the progress and completion of delegated tasks. As should be appreciated, a “delegated task” is a task that has been assigned to a responsible person for completion by a “delegator” or manager. Traditionally, such delegated tasks are not tracked within the manager's calendar/tasking application and, accordingly, the manager may find it difficult to track the progress of such delegated tasks. Moreover, it is commonplace for a delegator of a task to assign the task via a message or other informal means of communication. Not only so, but the delegator (e.g., sender of the message) and the responsible person (e.g., recipient of the message) may interact regarding the progress of a delegated task using a variety of different message types (e.g., email, text, instant messaging, voice mail, in-person communications, phone calls, etc.). The methods and systems herein provide a management tool in a centralized location (e.g., within an interface associated with a messaging application) for easily tracking the progress and completion of a plurality of delegated tasks.

In aspects, a computer system is provided. The computer system includes a processing unit and a memory storing computer executable instructions that, when executed by the processing unit, cause the computer system to perform a method. The method includes receiving a message from a sender and determining that the message delegates a task. The method further includes identifying one or more parameters associated with the delegated task and sending the message to a recipient. Additionally, the method includes monitoring a progress of the delegated task by the recipient and providing a status of the delegated task to the sender.

In further aspects, a method for managing a delegated task performed by a computing device is provided. The method includes retrieving the delegated task and monitoring a progress of the delegated task by a recipient. The method further includes determining whether at least one progress update has been received for the delegated task and providing a notification to the sender regarding the progress of the delegated task.

In still further aspects, a computer-readable storage medium is provided. The computer-readable storage medium stores computer executable instructions that, when executed by a processing unit, cause a computing device to receive a message from a sender and determine that the message delegates a task. The computer executable instructions further causing the computing device to identify one or more parameters associated with the delegated task and send the message to a recipient. Additionally, the computer executable instructions cause the computing device to monitor a progress of the delegated task by the recipient and provide a visual representation of the progress of the delegated task to the sender.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a system for creating and tracking delegated tasks, according to an example embodiment.

FIG. 2 illustrates a method for creating a delegated task, according to an example embodiment.

FIG. 3 illustrates a method for receiving progress updates and generating notifications for a delegated task, according to an example embodiment.

FIG. 4A illustrates an interface for receiving a message, according to an example embodiment.

FIG. 4B illustrates an interface for creating a delegated task in a message, according to an example embodiment.

FIG. 4C illustrates an interface for receiving parameters for a delegated task, according to an example embodiment.

FIGS. 5A and 5B illustrate an interface for receiving parameter values and setting reminders for a delegated task, according to an example embodiment.

FIG. 6 illustrates an interface displaying a reply email and a progress bar for a delegated task, according to an example embodiment.

FIG. 7 illustrates an interface with a delegated tasks pane for tracking progress of a plurality of delegated tasks, according to an example embodiment.

FIG. 8 illustrates an interface with a delegated tasks pane for updating parameters for a delegated task, according to an example embodiment.

FIGS. 9A and 9B illustrate an interface for updating one or more parameters of a delegated task, according to an example embodiment.

FIG. 10 is a block diagram illustrating example physical components of a computing device with which aspects of the disclosure may be practiced.

FIGS. 11A and 11B are simplified block diagrams of a mobile computing device with which aspects of the present disclosure may be practiced.

FIG. 12 is a simplified block diagram of a distributed computing system in which aspects of the present disclosure may be practiced.

FIG. 13 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As described above, the disclosure generally relates to a system and methods for tracking the progress and completion of delegated tasks. A “delegated task” is a task that has been assigned to a responsible person for completion by a “delegator” or manager. Traditionally, such delegated tasks are not tracked within the manager's calendar/tasking application and, accordingly, the manager may find it difficult to track the progress of such delegated tasks. Moreover, it is commonplace for a delegator of a task to assign the task via a message or other informal means of communication. Not only so, but while the delegated task is pending, the delegator (e.g., sender of the message) and the responsible person (e.g., recipient of the message) may interact regarding the progress of the delegated task using a variety of different message types (e.g., email, text, instant messaging, voice mail, in-person communications, phone calls, etc.). The methods and systems herein provide a management tool in a centralized location (e.g., within an interface associated with a messaging application) for easily tracking the progress and completion of a plurality of delegated tasks. It is with respect to these and other general considerations that embodiments have been made.

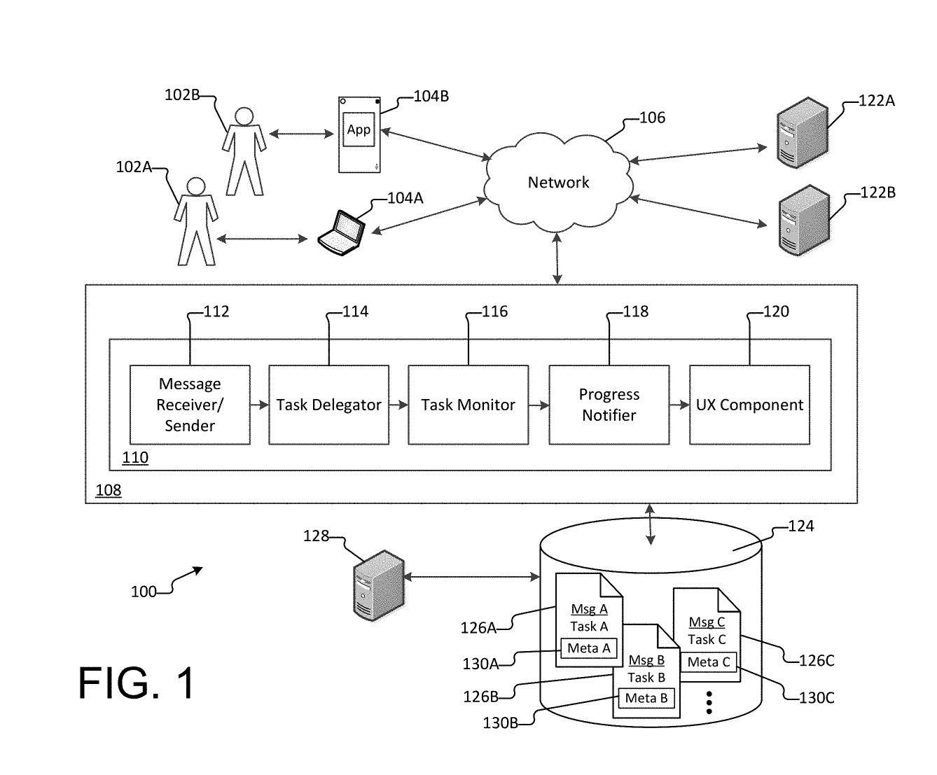

FIG. 1 illustrates a system for creating and tracking delegated tasks, according to an example embodiment.

As illustrated, system 100 may include one or more client computing devices 104 (e.g., client computing devices 104A and 104B) that may execute a client version of a task delegation manager capable of tracking the progress of delegated tasks. In some examples, the client task delegation manager may execute locally on a client computing device 104. In other examples, a client task delegation manager (e.g., a mobile app on a thin client computing device 104) may operate in communication (e.g., via network 106) with a corresponding server version of task delegation manager 110 executing on one or more server computing devices, e.g., server computing device 108. In still other aspects, rather than executing a client version of a task delegation manager, the one or more client computing devices 104 may remotely access, e.g., over network 106, the task delegation manager 110 implemented on the server computing device 108 or multiple server computing devices (e.g., in a distributed computing environment such as a cloud-computing environment). In aspects, the task delegation manager, whether executed on a client, a server, or in a cloud-computing environment, may be integrated into or in communication with an electronic mail or messaging application, a co-authoring application, a peer-to-peer application, a presentation application, a spreadsheet application, and the like.

As illustrated by FIG. 1, a server version of task delegation manager 110 is implemented by server computing device 108. As should be appreciated, the server version of task delegation manager 110 may also be implemented in a distributed environment (e.g., cloud-computing environment) across a plurality of server computing devices (not shown). Moreover, as should be appreciated, either a client or a server version of the task delegation manager 110 may be capable of tracking the progress of delegated tasks. While a server version of the task delegation manager 110 and associated components 112-120 are shown and described, this should not be understood as limiting. Rather, a client version of task delegation manager 110 may similarly implement components 112-120 on a client computing device 104.

In a basic configuration, the one or more client computing devices 104 are personal or handheld computers having both input elements and output elements operated by one or more users 102 (e.g., user 102A and user 102B). In some instances, users 102A and 102B may include a sender and a receiver of a message. For example, the one or more client computing devices 104 may include one or more of: a mobile telephone; a smart phone; a tablet; a phablet; a smart watch; a wearable computer; a personal computer; a desktop computer; a laptop computer; a gaming device/computer (e.g., Xbox®); a television; and the like. This list is exemplary only and should not be considered as limiting. Any suitable client computing device for executing a task delegation manager and/or remotely accessing task delegation manager 110 may be utilized.

In some aspects, network 106 is a computer network such as an enterprise intranet and/or the Internet. In this regard, the network 106 may include a Local Area Network (LAN), a Wide Area Network (WAN), the Internet, wireless and wired transmission mediums. In further aspects, server computing device 108 may communicate with some components of the system via a local network (e.g., an enterprise intranet), whereas server computing device 108 may communicate with other components of the system via a wide area network (e.g., the Internet). In addition, the aspects and functionalities described herein may operate over distributed systems (e.g., cloud-computing systems), where application functionality, memory, data storage and retrieval, and various processing functions may be operated remotely from each other over a distributed computing network, such as the Internet or an intranet.

As described above, the task delegation manager 110 may be implemented on a server computing device 108. In a basic configuration, server computing device 108 may include at least a processing unit and a system memory for executing computer-readable instructions. In some aspects, server computing device 108 may comprise one or more server computing devices 108 in a distributed environment (e.g., cloud-computing environment). Server computing device 108 may monitor and track the progress of delegated tasks communicated between the one or more client computing devices 104 and/or one or more other server computing devices (e.g., server computing devices 122A and/or 122B) via network 106.

As used herein, a message may be a communication via any computerized means between users, e.g. via an email messaging system (e.g. Microsoft® Outlook®, Gmail®, Mozilla® Thunderbird®, etc.), a text messaging system (e.g. SMS text, Apple® iMessage®, Google® Hangouts, etc.), an instant messaging system (e.g., AOL AIM, Microsoft® Lync®, Facebook® Messenger, WhatsApp®, Google® Chat, Tencent® QQ, Google® Hangouts™ etc.), a video messaging system (e.g., Microsoft® Skype®, SnapChat®, Google® Hangouts on Air™, etc.), a collaborative message board (e.g., Slack®, Microsoft® Yammer™, etc.), and the like. In some aspects, task delegation manager 110 may receive messages in any format for delegating a task and/or for tracking progress of the delegated task between a sender and at least one recipient. In further aspects, a message may include one or more attachments. Attachments may include any form of digital content attachable to a message, e.g., a photograph, a document, another message, an audio file, a video file, a hyperlink, and the like. A message may also include metadata, which among other things may indicate that the message is associated with a delegated task (e.g., by “flagging” the message) and/or may identify one or more parameters associated with the delegated task (e.g., sent time, receipt time, sender identifier, receiver identifier, attachment identifier, etc.).

As should be appreciated, one or more messages (e.g., messages 126A, 126B, and 126C) may be received and stored in one or more storage locations accessible to task delegation manager 110, e.g., storage 128. In at least some examples, the one or more messages may be stored in different storage locations within a distributed environment (e.g., cloud-based computing environment) that is accessible to the task delegation manager 110 over a network, e.g., network 106. In aspects, the one or more message may be associated with a delegated task, e.g., task A associated with message 126A, task B associated with message 126B, and task C associated with message 126C. In some aspects, a sender of the message may indicate that the message is associated with a delegated task. In other aspects, the task delegation manager 110 may determine that the message is associated with a delegated task, e.g., by natural language processing or other means. Additionally, messages 126A, 126B, and 126C may be associated with metadata, e.g., metadata 130A, 130B, and 130C. Such metadata may indicate, among other things, that a message is associated with a delegated task and, in some cases, a reply message may include the same or similar metadata indicating that the reply message is associated with the delegated task. As shown, metadata 130A is associated with message 126A, metadata 130B is associated with message 126B, and metadata 130C is associated with message 126C. As detailed above, the one or more messages may be generated by a messaging application (e.g., email application, instant messaging application, etc.) that may be hosted by server computing device 108 or by another server computing device (e.g., server computing devices 122A, 122B and/or 128).

As illustrated in FIG. 1, the task delegation manager 110 may include various components for monitoring and tracking the progress of delegated tasks, including a message receiver/sender 112, a task delegator 114, a task monitor 116, a progress notifier 118, and a UX component 120, and the like. In aspects, each component may communicate and pass data between the other components. The various components may be implemented using hardware, software, or a combination of hardware and software. Moreover, the various components may be executed on a single server computing device (e.g., server computing device 108), on multiple server computing devices (e.g., server computing devices 122A, 122B and/or 128), or locally on a client computing device (e.g., client computing device 104A or 104B).

As described above, the task delegation manager 110 may be configured to receive an indication of a delegated task, monitor the progress of the delegated task, and provide a notification regarding the progress and/or completion of the delegated task. In aspects, message receiver/sender 112 may receive a message. As detailed above, a message may be a communication via any computerized means between users, e.g. via an email messaging system, a text messaging system, an instant messaging system, a video messaging system, a collaborative message board, and the like. In some aspects, a message may be received from a sender as input into a messaging application. In further aspects, the sender may specify that the message is associated with a delegated task. For instance, the sender may indicate that the message is associated with a delegated task by selecting a “task” control, button, check box, and the like. The sender may make such an indication prior to sending the message (e.g., when composing the message) or after sending the message (e.g., by selecting a “task” flag associated with the message in the sender's “sent items” list). In other cases, the message receiver 112 may determine that the message is associated with a delegated task via any suitable means (e.g., natural language processing). When a message is identified as associated with a delegated task, metadata may be appended to the message that flags the message as associated with a delegated task and/or identifies the delegated task. In further aspects, message receiver/sender 112 may also send the message including the delegated task to at least one recipient via any suitable communication means.

In response to determining that a message is associated with a delegated task, task delegator 114 may identify one or more parameters associated with the message and/or the delegated task. For instance, task delegator 114 may identify one or more recipients of the message, a description of the delegated task, a deadline for the delegated task, a follow-up date for the delegated task, one or more documents associated with the delegated task (e.g., attached to the message), and the like. In some cases, a single recipient may be responsible for a delegated task; while in other cases, more than one recipient may be responsible for a delegated task. In further aspects, one delegated task may be dependent on completion of another delegated task. In some cases, a delegated task may be associated with a hard deadline; whereas in other cases, a delegated task may be associated with a soft deadline. In response to identifying one or more parameters associated with the delegated task, in some aspects, the one or more of the parameters may be appended as metadata to the message. The above examples are provided for purposes of explanation should not be considered to be limiting.

Task monitor 116 may monitor progress and/or completion of a delegated task. For instance, e.g., based on metadata associated with the message, task monitor 116 may evaluate any “reply” messages to the message for indications of progress and/or completion of the delegated task. Additionally or alternatively, task monitor 116 may determine whether the recipient opened the message and/or opened one or more attachments associated with the message. Additionally or alternatively, task monitor 116 may receive an indication from the sender regarding a progress and/or completion of a delegated task. As detailed above, a recipient of a delegated task may communicate progress and/or completion of the delegated task via a variety of electronic communication means, e.g., email, text, instant message, video message, message board, etc., as well as via “off-line” communication means such as a phone call, a video conference, an in-person communication, etc. As a result of the variety of communication types by which a sender may receive updates regarding a delegated task, the system disclosed here enables a sender (delegator) of a task to easily and directly update a progress and/or completion of a delegated task. For instance, as described further with respect to progress notifier 118 and UX component 120, a “delegated tasks” pane (or interface) may be provided within an interface of a messaging application, e.g., an email application, a collaborative workspace associated with an enterprise or other collaborative application, a calendaring application, etc. The delegated tasks pane (or interface) may provide a listing of each delegated task, which may be selected and updated by the sender as information regarding the progress and/or completion of a delegated task becomes available.

Progress notifier 118 may provide active and/or passive notifications regarding the progress and/or completion of a delegated task to a sender. For instance, active notifications may involve follow-up reminders to the sender when a progress update for a delegated task has not been received within a period of time. Follow-up reminders may be provided to the sender via a calendaring and/or task application interface, as a text message, as an instant message, as an email message, and the like. In some examples, the follow-up reminder may automatically launch or attach the original message by which the sender delegated the task. Additionally or alternatively, the follow-up reminder may include an option to launch a messaging application for sending the recipient(s) of the delegated task a reminder message (e.g., via text, email, instant message, etc.). In this way, rather than simply “reminding” the sender to follow-up with the recipient, the follow-up reminder may provide means whereby the sender can easily follow-up, e.g., by sending a reminder message and/or by resending the original message to the recipient with a request for a progress update. The period of time for issuing a follow-up reminder may be a default time period (e.g., two weeks after delegating the task, 1 week prior to the deadline, etc.) or may be set by the sender (e.g., when the task is delegated, when a progress update is received, etc.). In some aspects, follow-up reminders may be recurring (e.g., every two weeks, every week, one week after each progress update, etc.)

In other aspects, active notifications may involve status updates regarding one or more delegated tasks. For instance, an active notification may provide a summary of the progress of pending delegated tasks via a calendaring and/or task application interface, as a text message, as an instant message, as an email message, and the like. The progress summary notification may include all pending delegated tasks or may include a subset, e.g., delegated tasks for which an update has not been received within a period of time, delegated tasks that are past due, delegated tasks that are within one day or one week of the deadline, etc. In some aspects, as described above, the sender may select any of the pending delegated tasks to initiate follow-up directly from the active notification. As should be appreciated, the above examples are provided for purposes of explanation should not be considered to be limiting.

In still other aspects, progress notifier 118 may provide passive notifications to sender. For instance, the progress of delegated tasks may be provided in a delegated tasks pane within a messaging interface, as described above. In some aspects, the progress of the delegated tasks may be continuously updated and displayed in a delegated tasks pane or window, as described above. The delegated tasks pane may provide visual or textual notifications associated with one or more of the delegated tasks. In some cases, different visual or textual notifications may be provided near a delegated task based on an urgency or an importance of the delegated task. For instance, when a progress update for a delegated task has not been received within the period of time, a first type of visual notification may be provided (e.g., a yellow exclamation mark, yellow bell icon, etc.) and/or a first type of textual notification may be provided (e.g., “You have not received an update in two weeks,” etc.). Alternatively, when the deadline for a delegated task is near (or the delegated task is of high importance) and the delegated task has not been completed, a second type of visual notification may be provided (e.g., a red exclamation mark, red bell icon, etc.) and/or a second type of textual notification may be provided (e.g., “Deadline approaching!” or “Deadline in two days!” and the like). In still other aspects, when a delegated task is past due, a third type of visual notification may be provided (e.g., multiple red exclamation marks, etc.) and/or a third type of textual notification may be provided (e.g., “PAST DUE!” and the like). In some cases, the visual reminders and/or textual reminders may be selectable from the delegated tasks pane for sending a reminder message to the recipient of the delegated task. In other cases, a selectable control may be provided for sending a reminder message regarding one or more pending delegated tasks (e.g., a “Send reminder?” button or link).

UX component 120 may communicate with one or more other components to provide an interface for viewing and/or accessing (or opening) one or more delegated tasks. In aspects, UX component 120 may provide a “delegated tasks pane” within a messaging interface, as described above. In some aspects, UX component 120 may present a list of one or more delegated tasks with numeric progress indicators (e.g., 50% complete, 2 of 3 tasks completed, etc.). In other aspects, UX component 120 may provide the status of one or more delegated tasks as a bar, bar graph, meter, pie chart, or any other form of graphic indicator. As described above, the delegated tasks pane may be an interactive interface. For instance, each of the one or more delegated tasks may be selectable so as to display the one or more parameters associated with the delegated task (e.g., recipient(s), deadline, assignment date, follow-up schedule, follow-up history, progress update history, and the like). In some aspects, the one or more parameters may be editable. For instance, deadlines, follow-up schedules, notification type, etc., may be edited by the sender/delegator. Additionally, one or more controls may be provided within the delegated tasks pane for sending reminders, updating progress, marking a delegated task complete, changing a type of visual representation for displaying task status (e.g., from a bar to a pie chart, etc.), and the like.

As should be appreciated, the various devices, components, etc., described with respect to FIG. 1 are not intended to limit the systems and methods to the particular components described. Accordingly, additional topology configurations may be used to practice the methods and systems herein and/or some components described may be excluded without departing from the methods and systems disclosed herein.

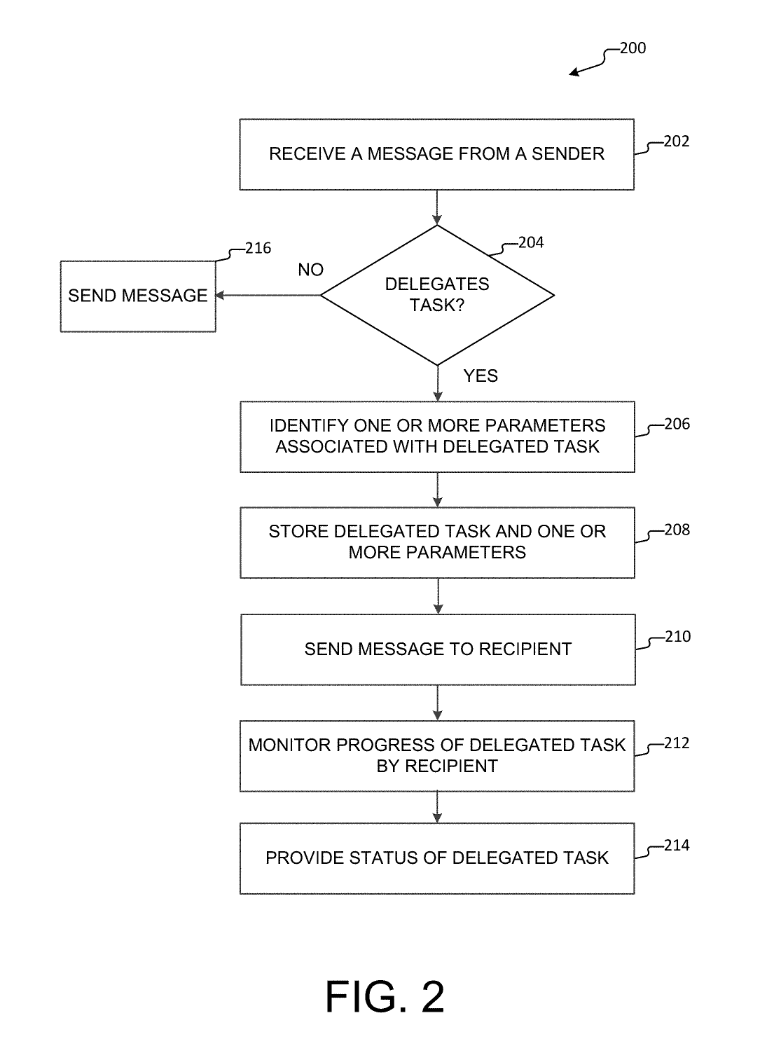

FIG. 2 illustrates a method for creating a delegated task, according to an example embodiment.

Method 200 begins with receive message operation 202, where a task delegation manager such as task delegation manager 110 (or an application in communication with the task delegation manager 110) may receive a message from a sender. Applications in communication with the task delegation manager 110, as detailed above, may include messaging applications such as an email messaging application, a text messaging application, an instant messaging application, a video messaging application, a collaborative message board, and the like. In aspects, a UX component (e.g., UX component 122) may facilitate a user experience (UX) by providing a user interface (UI) for receiving the message. Selections and/or inputs of the message may be received by the UI based on gestures, touch, mouse movements, and the like. The UI may operate in conjunction or communication with one or more other components of task delegation manager 110 (e.g., message receiver/sender 112) when receiving the message. For instance, the message may be received in response to a user typing, cutting and pasting, or otherwise inputting content of the message into a UI, or any other suitable method for receiving the message.

At determination operation 204, it is determined whether the message is associated with a delegated task. In aspects, message receiver/sender 112 and/or task delegator 114 of task delegation manager 110 may determine whether the message is associated with a delegated task. In some cases, the sender may specify that the message is associated with a delegated task. For instance, the sender may indicate that the message is associated with a delegated task by selecting a “task” control, button, check box, and the like. The sender may make such an indication prior to sending the message (e.g., when composing the message) or after sending the message (e.g., by selecting a “task” flag associated with the message in the sender's “sent items” list). Alternatively, based on content of the message, it may be determined that the message is associated with a delegated task (e.g., natural language processing). As should be appreciated, any of a variety of types of messages (e.g., email message, text message, instant message, etc.) may be identified as associated with a delegated task. Accordingly, a sender may choose any suitable message type to communicate a delegated task to a recipient and each delegated task may be flagged for tracking within a single, unified task interface by the task delegation manager 110. In this way, management challenges with tracking the progress of delegated tasks assigned through various message types are alleviated. For instance, when the message is identified as associated with a delegated task, metadata may be appended to the message that flags the message as associated with a delegated task and/or identifies the delegated task. If the message is determined to be associated with a delegated task, the method proceeds to operation 206. If the message is not determined to be associated with a delegated task, the method proceeds to operation 216.

At identify operation 206, one or more parameters may be identified for the delegated task. In aspects, task delegator 114 of task delegation manager 110 may identify one or more parameters associated with the delegated task. For instance, identified parameters may include one or more recipients of the message, a description of the delegated task, a deadline for the delegated task, a follow-up date for the delegated task, one or more documents associated with the delegated task (e.g., attached to the message), and the like. In some aspects, as further described below, one or more parameters may be identified based on input from the sender of the message (delegator of the task). Such parameters may include, for instance, a task description (or subject), priority of the message (e.g., low, normal, high), status of the message (e.g., not started, in progress, waiting on someone else, deferred, completed, etc.), % complete for the task, reminder date and time (or a recurring schedule for a reminder), a reminder sound, and the like. In other aspects, the task delegation manager may automatically determine one or more parameters for the delegated task. For instance, a subject for the delegated task may be identified based on a subject line of the message, a responsible person (or persons) may be identified based on a recipient (or recipients) of the message, a deadline for the delegated task may be identified based on content of the message (e.g., via natural language processing, it may be determined that a deadline of “this Thursday” is “Jun. 9, 2015” based on a sent time for the message), and the like.

At store operation 208, the delegated task and the one or more identified parameters may be stored. In aspects, task delegator 114 of task delegation manager 110 may store the delegated task and the one or more parameters. For example, the delegated task may be stored in any suitable memory or database in any suitable data structure. In some cases, the data structure may include one or more fields corresponding to one or more parameter types that are populated with one or more parameter values. For example, parameter type “deadline” may be populated with parameter value “Jun. 9, 2015” within a corresponding field of a data structure storing the delegated task. In further cases, an interface for a delegated task may be generated based on a data structure corresponding to the delegated task. That is, parameter types corresponding to fields stored in a data structure may be provided in an interface for receiving parameter values as input from the message sender. For instance, the task delegator interface may provide text boxes, drop-down menus, etc., for receiving one or more parameter values for a delegated task. In some cases, some parameter types may be automatically populated with parameter values in the task delegator interface based on their automatic identification by the task delegation manager, as described above.

At send message operation 210, the message is sent to at least one recipient. In aspects, message receiver/sender 112 of task delegation manager 110 may send the message with the delegated task to the recipient. As should be appreciated, the message may be of any message type, as described above, and may be sent via any suitable communications means. For instance, the message may be an email message, a text message, an instant message, a video message, a message on a message board, and the like. As the message has been determined to be associated with a delegated task (see determination operation 204), the at least one recipient may also be the responsible person for completing the task.

At monitor operation 212, a progress of a delegated task is monitored. In aspects, task monitor 116 of task delegation manager 110 may monitor a progress and/or completion of the delegated task. For instance, e.g., based on metadata associated with the message, “reply” messages to the message may be monitored for indications of progress and/or completion of the delegated task. Additionally or alternatively, it may be determined whether the recipient opened the message and/or opened one or more attachments associated with the message. In some cases, an indication from the sender regarding a progress and/or completion of a delegated task may be received. For instance, the sender may update the delegated task by updating parameter values (e.g., for parameter type “status” or parameter type “% complete”) within a task delegator interface. As detailed above, a recipient of a delegated task may communicate progress and/or completion of the delegated task via a variety of electronic communication means, e.g., email, text, instant message, video message, message board, etc., as well as via “off-line” communication means such as a phone call, a video conference, an in-person communication, etc. As a result of the variety of communication types by which a sender may receive updates regarding a delegated task, the system disclosed here enables a sender (delegator) of a task to easily and directly update a progress and/or completion of a delegated task.

At provide status operation 214, a progress and/or completion of a delegated task is provided to the sender. For example, a UX component 120 of task delegation manager 110 may communicate with one or more other components to provide an interface for viewing and/or accessing one or more delegated tasks. Statuses of delegated tasks may be provided via a “delegated tasks pane” within a messaging interface, as described above. In some cases, a list of one or more delegated tasks may be provided, each delegated task with a numeric progress indicator (e.g., 50% complete, 2 of 3 tasks completed, etc.). In other aspects, the status of one or more delegated tasks may be provided as a bar, bar graph, meter, pie chart, or any other form of graphic indicator. As described above, the delegated tasks pane may be an interactive interface. For instance, each of the one or more delegated tasks may be selectable so as to display one or more parameters associated with the delegated task (e.g., recipient(s), deadline, assignment date, follow-up schedule, follow-up history, progress update history, and the like). In some aspects, the one or more parameters may be editable. For instance, parameters such as deadline, follow-up schedule, notification type, etc., may be edited by the sender/delegator. Additionally, one or more controls may be provided within the delegated tasks pane for sending reminders, updating progress, marking a delegated task complete, changing a type of visual representation for displaying task status (e.g., from a bar to a pie chart, etc.), and the like.

As should be appreciated, the tasks described herein are referred to as “delegated tasks” because the sender (delegator) of the task is not the responsible person for completing the task. Traditionally, such “delegated” tasks are not tracked within the sender's calendar/tasking application and the sender may find it difficult to manage such delegated tasks. Not only so, but when task assignments are made through a variety of message types, the sender (delegator) may find it difficult to keep track of disparate tasks and responsible individuals. The methods and systems herein provide a management tool in a centralized location (e.g., within an interface associated with a messaging application) for facilitating monitoring the progress and/or completion of a plurality of delegated tasks.

At send message operation 216, the message is sent to at least one recipient. In aspects, message receiver/sender 112 may send the message to the recipient. Alternatively, as the message is not associated with a delegated task (see determination operation 204), any suitable messaging application may send the message to the recipient.

As should be appreciated, operations 202-216 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

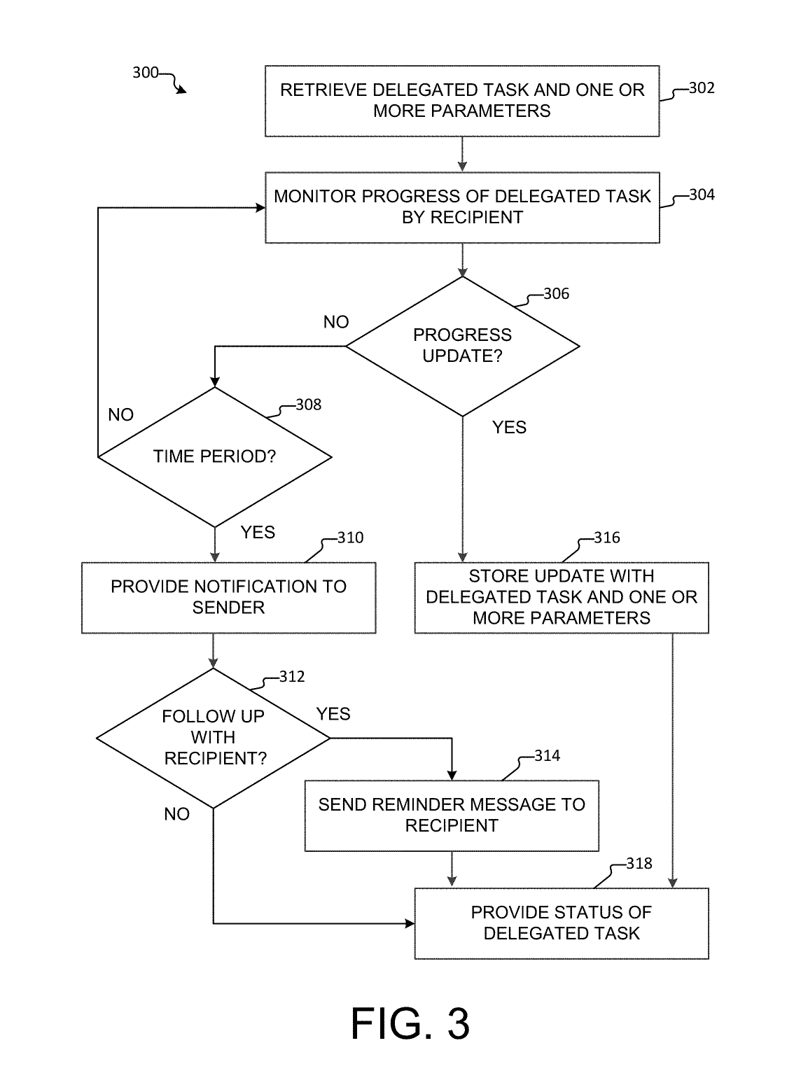

FIG. 3 illustrates a method for receiving progress updates and generating notifications for a delegated task, according to an example embodiment.

Method 300 begins with retrieve delegated task operation 302, where a delegated task and one or more parameters are retrieved. For instance, the delegated task and the one or more parameters may be retrieved from a data structure in memory. In some cases, the data structure may include one or more fields corresponding to one or more parameter types that are populated with one or more parameter values. For example, parameter type “deadline” may be populated with parameter value “Jun. 9, 2015” within a corresponding field of a data structure storing the delegated task. In further cases, an interface for a delegated task may be provided for retrieving the delegated task and the one or more parameters, as described above.

At monitor operation 304, a progress of a delegated task is monitored. In aspects, as described above for monitor operation 212, task monitor 116 of task delegation manager 110 may monitor a progress and/or completion of the delegated task. For instance, e.g., based on metadata associated with the message, “reply” messages to the message may be monitored for indications of progress and/or completion of the delegated task. Additionally or alternatively, it may be determined whether the recipient opened the message and/or opened one or more attachments associated with the message. In some cases, an indication from the sender regarding a progress and/or completion of a delegated task may be received.

At progress determination operation 306, it may be determined whether a progress update for the delegated task has been received. For instance, the sender may update the delegated task by updating parameter values within a task delegator interface. That is, in response to receiving a communication from the recipient, the sender may update parameter type “status” from “Not Started” to “In Progress.” Alternatively, the sender may update parameter type “% complete” from “0%” to “30%,” and the like. In other cases, a task monitor 116 may receive an update to a task via another means, e.g., the task monitor may receive an indication that the message and/or an attachment to the message was opened (e.g., “Read”) by the recipient and may update the progress of the delegated task accordingly. If a progress update has been received for the delegated task, the method may proceed to store operation 316. If a progress update has not been received for the delegated task, the method may proceed to time period determination operation 308.

At time period determination operation 308, it may be determined whether a time period has expired. As described above, a time period may be set for sending follow-up reminders to the sender. The period of time for issuing a follow-up reminder may be a default time period (e.g., two weeks after delegating the task, 1 week prior to the deadline, etc.), may be set by the sender (e.g., when the task is delegated, when a progress update is received, etc.) and/or may be based on the delegated task (e.g., a longer period of time for a distant deadline and a shorter period of time for a close deadline). The time period may also be recurring (e.g., every two weeks, every week, one week after each progress update, etc.). In some cases, as described above, the sender may select a time period within the task delegator interface. If the time period has expired, the method may proceed to provide notification operation 310. If the time period has not expired, the method may return to monitor operation 304.

At provide notification operation 310, a notification regarding the status of the delegated task may be provided to the sender (delegator) of the task. For instance, as detailed above, active and/or passive notifications regarding the progress and/or completion of a delegated task may be provided to a sender. Active notifications may involve sending follow-up reminders to the sender when a progress update for a delegated task has not been received within the period of time. Follow-up reminders may be provided to the sender via a calendaring and/or task application interface, as a text message, as an instant message, as an email message, and the like.

Alternatively, at provide notification operation 310, passive notifications may be provided to the sender. In some aspects, the progress of the delegated tasks may be continuously updated and displayed in a delegated tasks pane or window, as described above. The delegated tasks pane may provide visual or textual notifications associated with one or more of the delegated tasks. In some cases, different visual or textual notifications may be provided near a delegated task based on an urgency or an importance of the delegated task. For instance, when a progress update for a delegated task has not been received within the period of time, a first type of visual notification may be provided (e.g., a yellow exclamation mark, yellow bell icon, etc.) and/or a first type of textual notification may be provided (e.g., “You have not received an update in two weeks,” etc.). Alternatively, when the deadline for a delegated task is near (or the delegated task is of high importance) and the delegated task has not been completed, a second type of visual notification may be provided (e.g., a red exclamation mark, red bell icon, etc.) and/or a second type of textual notification may be provided (e.g., “Deadline approaching!” or “Deadline in two days!” and the like). In still other aspects, when a delegated task is past due, a third type of visual notification may be provided (e.g., multiple red exclamation marks, etc.) and/or a third type of textual notification may be provided (e.g., “PAST DUE!” and the like).

At follow-up determination operation 312, it may be determined whether a reminder message should be sent to the recipient. For instance, when the time period has expired and an update has not been received regarding the progress and/or completion of a delegated task, the sender (delegator) may wish to send a reminder message to the recipient (responsible person). In some cases, the visual notifications and/or textual notifications may be selectable from the delegated tasks pane for sending a reminder message to the recipient of the delegated task. In other cases, a selectable control may be provided for sending a reminder message regarding one or more pending delegated tasks (e.g., a “Send reminder?” button or link). In still other aspects, an option may be provided to resend the original message including the delegated task and a request for a progress update. As should be appreciated, the systems and methods herein facilitate management of delegated tasks such that automatic reminders may be sent to the sender/delegator to follow up with the recipient regarding progress of a task, as well as generating easily selectable means for implementing follow up with a recipient. If follow-up with the recipient is desired, the methods proceed to send reminder operation 314. If follow-up is not desired, the methods proceed to provide status operation 318.

At send reminder message 314, a reminder message may be sent to the recipient regarding the delegated task. In some examples, in response to a selection to follow up with the recipient, a reminder message may automatically launch or attach the original message by which the sender delegated the task. Additionally or alternatively, a follow-up reminder to the sender may include an option to launch a messaging application for sending the recipient(s) of the delegated task a reminder message (e.g., via text, email, instant message, etc.). In some cases, the reminder message may be prepopulated with parameters of the delegated task (e.g., deadline, requested action, etc.) and may further be prepopulated with a default request for a progress update (e.g., “Please provide a progress update,” and the like). In this way, rather than simply “reminding” the sender to follow-up with the recipient, the follow-up reminder may provide means whereby the sender can easily follow-up.

At store operation 316, similar to store operation 208, the update may be stored with the delegated task and the one or more parameters. For example, the delegated task may be stored in any suitable memory or database in any suitable data structure. In some cases, the data structure may include one or more fields corresponding to one or more parameter types that are populated with one or more parameter values. When an update is received, one or more parameters may be updated. For instance, parameter type “deadline” may be updated from parameter value “Jun. 9, 2015” to “Jun. 11, 2015” within a corresponding field of a data structure storing the delegated task. Alternatively, a status of a delegated task may be updated from “In Progress” to “Complete,” and the like. In further cases, an interface for a delegated task may be generated for receiving updates to parameters. For instance, a task delegator interface may provide text boxes, drop-down menus, etc., for receiving updates to one or more parameter values for a delegated task.

At provide status operation 318, similar to provide status operation 214, a progress and/or completion of a delegated task is provided to the sender. Statuses of delegated tasks may be provided via a “delegated tasks pane” within a messaging interface, as described above. In some cases, a list of one or more delegated tasks may be provided, each delegated task with a numeric progress indicator (e.g., 50% complete, 2 of 3 tasks completed, etc.). In other aspects, the status of one or more delegated tasks may be provided as a bar, bar graph, meter, pie chart, or any other form of graphic indicator. As described above, the delegated tasks pane may be an interactive interface. For instance, each of the one or more delegated tasks may be selectable so as to display one or more parameters associated with the delegated task (e.g., recipient(s), deadline, assignment date, follow-up schedule, follow-up history, progress update history, and the like). In some aspects, the one or more parameters may be editable. For instance, parameters such as deadline, follow-up schedule, notification type, etc., may be edited by the sender/delegator. Additionally, one or more controls may be provided within the delegated tasks pane for sending reminders, updating progress, marking a delegated task complete, changing a type of visual representation for displaying task status (e.g., from a bar to a pie chart, etc.), and the like.

As should be appreciated, operations 302-318 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

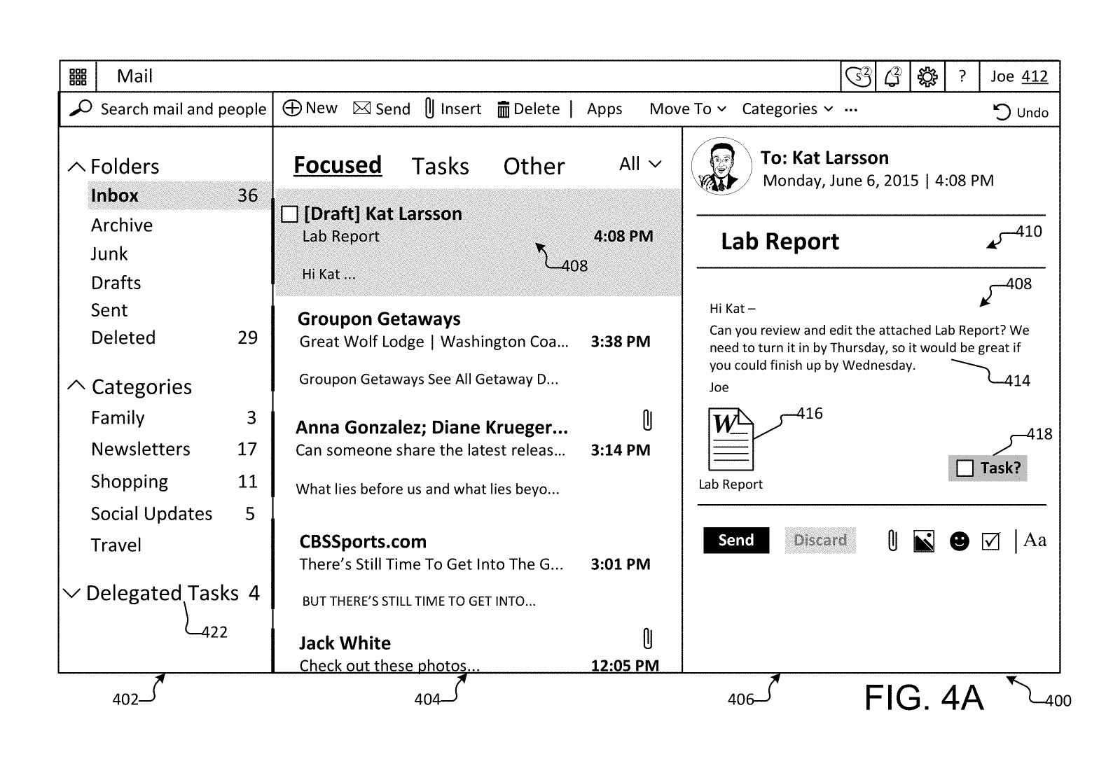

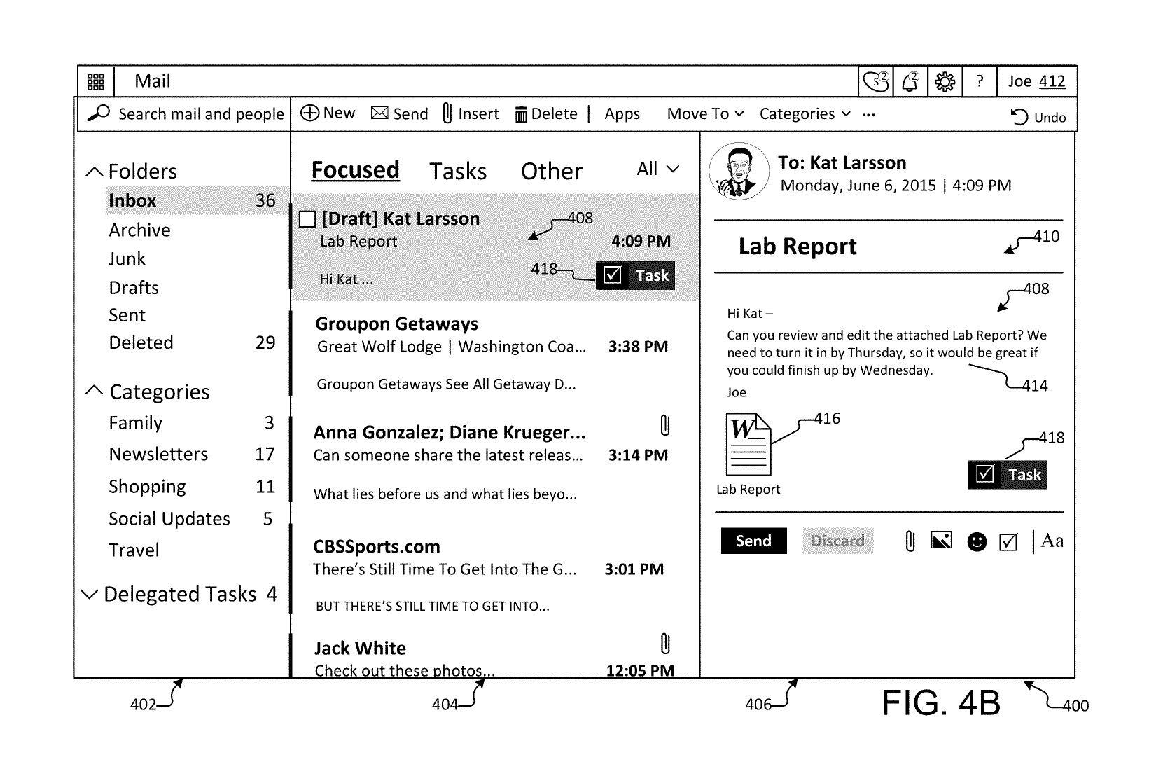

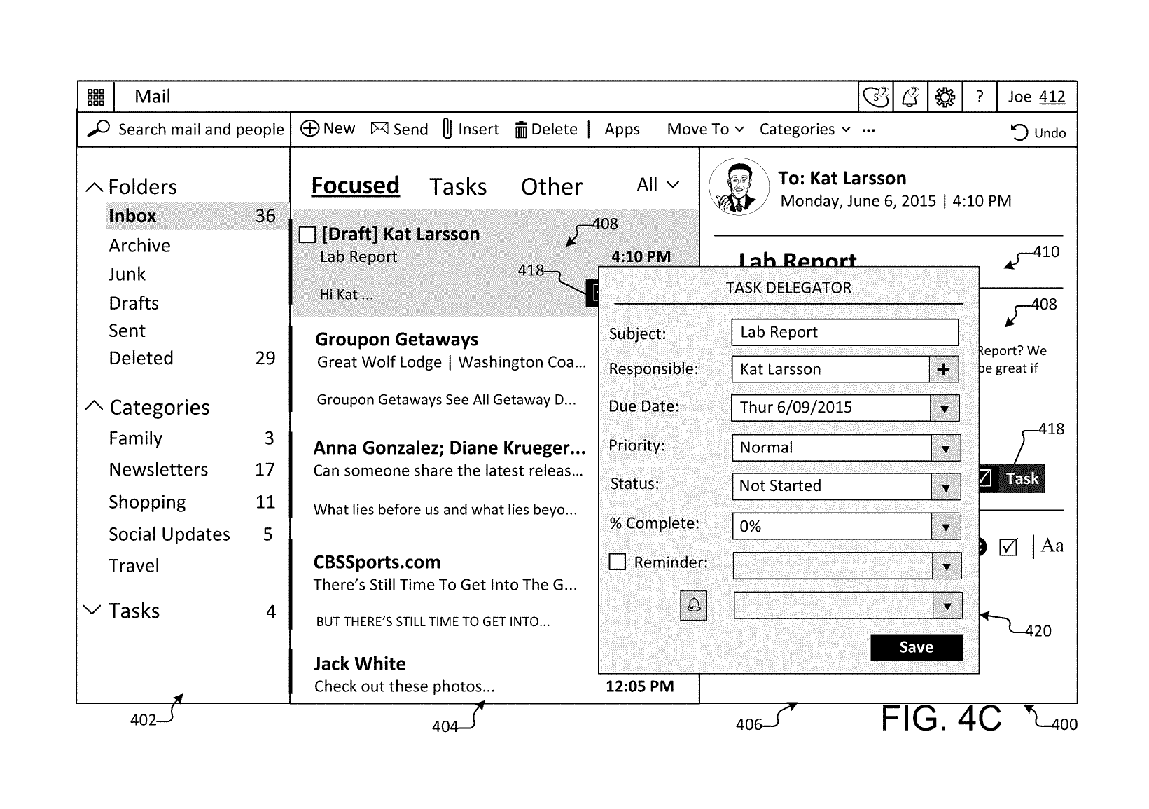

FIG. 4A illustrates an interface for receiving a message, according to an example embodiment.

As illustrated, an interface 400 of a messaging application (e.g., email application) is provided. Interface 400 includes a navigation pane 402, a list pane 404, and a reading pane 406. Email 408 is displayed in reading pane 406 and list pane 404. Email 408 includes a subject line 410, entitled “Lab Report,” and recipient “Kat Larsson.” As illustrated, email 408 is a draft email (see, e.g., list pane 404) that is being drafted by “Joe” (see, e.g., user identifier 412) at 4:08 PM on Monday, Jun. 6, 2015. Email 408 further includes a message 414, which states: “Hi Kat—Can you review and edit the attached Lab Report? We need to turn it in by Thursday, so it would be great if you could finish up by Wednesday.” Additionally, a document 416, entitled “Lab Report,” has been attached to email 408. The reading pane 406 further includes a “task control” 418. As described above, task control 418 may be selectable to indicate that a delegated task is associated with email 408. As illustrated, task control 418 is not selected, as shown by an empty check box associated with task control 418. As should be appreciated, while task control 418 is shown as a check box, other types of controls may be provided (e.g., selectable buttons, icons, hyperlinks, and the like). As further illustrated, a “delegated tasks” tab 422 identifies “4” delegated tasks.

As should be appreciated, the various devices, components, etc., described with respect to FIG. 4A are not intended to limit the systems and methods to the particular components described. Accordingly, additional topology configurations may be used to practice the methods and systems herein and/or some components described may be excluded without departing from the methods and systems disclosed herein.

FIG. 4B illustrates an interface for creating a delegated task in a message, according to an example embodiment.

Similar to FIG. 4A, FIG. 4B illustrates interface 400 of a messaging application. Interface 400 includes navigation pane 402, list pane 404, and reading pane 406. Email 408 is a draft email that is still being drafted by “Joe” (see, e.g., user identifier 412) at 4:09 PM on Jun. 6, 2015. Email 408 further includes message 414, detailed above, and document 416. In this case, however, task control 418 within reading pane 406 has been selected (as illustrated by a checked box) to indicate that a delegated task is associated with email 408. Similarly, in response to receiving an indication that email 408 is associated with a delegated task, task control 418 is reproduced with email 408 in the list pane 404.

As should be appreciated, the various devices, components, etc., described with respect to FIG. 4B are not intended to limit the systems and methods to the particular components described. Accordingly, additional topology configurations may be used to practice the methods and systems herein and/or some components described may be excluded without departing from the methods and systems disclosed herein.

FIG. 4C illustrates an interface for receiving parameters for a delegated task, according to an example embodiment.

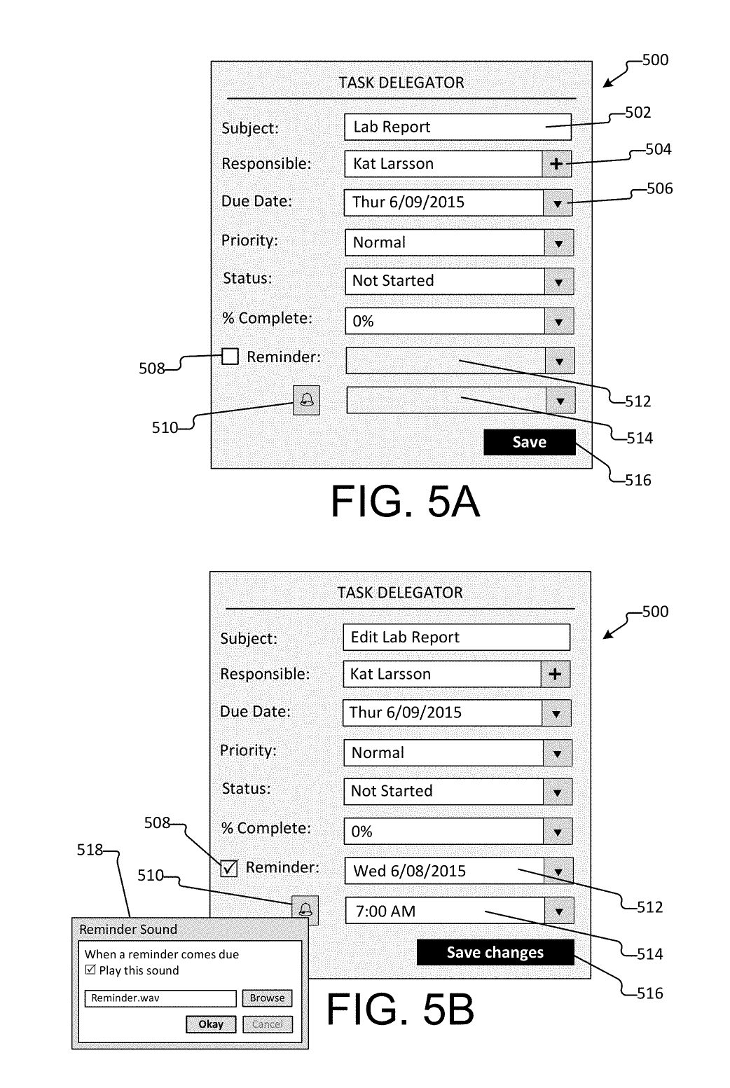

Similar to FIG. 4A and 4B, FIG. 4C illustrates interface 400 of a messaging application. Interface 400 includes navigation pane 402, list pane 404, and reading pane 406. Email 408 is a draft email that is still being drafted by “Joe” (see, e.g., user identifier 412) at 4:10 PM on Jun. 6, 2015. In some cases, as illustrated, in response to selecting task control 418 within reading pane 406, a “task delegator interface” 420 may be launched as a window. As described further with respect to FIGS. 5A and 5B, task delegator interface 420 may display one or more parameter types with corresponding text boxes, drop-down menus, etc., for receiving and/or prepopulating parameter values associated with a delegated task.

As should be appreciated, the various devices, components, etc., described with respect to FIG. 4C are not intended to limit the systems and methods to the particular components described. Accordingly, additional topology configurations may be used to practice the methods and systems herein and/or some components described may be excluded without departing from the methods and systems disclosed herein.

FIGS. 5A and 5B illustrate an interface for receiving parameter values and setting reminders for a delegated task, according to an example embodiment.

Similar to task delegator interface 420, a first and second view of a task delegator interface 500 is provided. Task delegator interface 500 provides a text box 502 for receiving a subject (or task descriptor) for the delegated task. In this way, the sender (delegator) may input a subject for the delegated task. In at least some aspects, the subject for the delegated task may be automatically populated based on a subject line of the message, e.g., subject line 410 of FIG. 4A. Task delegator interface 420 further provides an “add” (“+”) control 504 for adding responsible individuals for the delegated task. In some aspects, the responsible individual may be automatically populated based on a recipient of the message. However, the sender may input additional responsible people if desired using the add control 504.

Additionally, the task delegator interface 500 provides a number of drop-down menus for receiving parameters such as “Due Date,” “Priority,” “Status,” and “% Complete.” In some cases, parameter type “due date” may be prepopulated based on content of the message or other indicators. For instance, if the message states, “We have a hard deadline on November 1,” the task delegation manager may determine that the due date is “Nov. 1, 2015” based on the current year. Alternatively, if the message states, “We need to turn this in by Thursday,” task delegation manager may determine that the due date is “Jun. 9, 2015” based on the current date. Alternatively, the sender may input the due date using drop down 506. In further examples, some parameter types may be prepopulated with default parameter values. For instance, a “Priority” parameter type may be prepopulated with a default parameter value of “Normal.” Alternatively, the “Priority” parameter type may be prepopulated based on content of the message. For instance, if the message states, “URGENT! We have to get this in today,” task delegation manager may determine that the delegated task has a “High” priority rather than a “Normal” priority. Similarly, a “% Complete” parameter type may be prepopulated with a default parameter value of “0%.”

Task delegator interface 500 further provides for selecting (e.g., by checking a check box control 508) a reminder date and time for the delegated task. In response to selecting check box control 508, a reminder date may be entered in date input field 512, a reminder time may be entered in time input field 514 and an alarm button 510 may become actionable for selecting an alarm sound. As illustrated by FIG. 5A, check box control 508 is not selected (or checked) and date input field 512 and time input field 514 are “grayed out” and unavailable for input. Save control 516 is provided for storing the one or more parameter values associated with the delegated task, whether the parameter values have been automatically populated or input by the sender.

As illustrated by FIG. 5B, check box control 508 is selected (as evidenced by a checked box). In this case, date input field 512 has been populated with date “Jun. 8, 2015” and time input field 514 has been populated with time “7:00 AM.” In aspects, date “Jun. 8, 2015” may be a default date (e.g., one day before the due date of “Thur Jun. 9, 2015”) and time “7:00 AM” may be a default time (e.g., early in the day), or either input field may be populated by the sender. Additionally, alarm button 510 is shown as selected and popup interface 518 is provided for selection of an alarm sound. In response to selection of check box control 508 and entry of parameter values date “Jun. 8, 2015” and time “7:00 AM,” save control 516 provides for “Save changes,” rather than “Save.” In this way, by selecting save control 516, updates to the one or more parameters may be stored for the delegated task.

As should be appreciated, the various devices, components, etc., described with respect to FIGS. 5A and 5B are not intended to limit the systems and methods to the particular components described. Accordingly, additional topology configurations may be used to practice the methods and systems herein and/or some components described may be excluded without departing from the methods and systems disclosed herein.

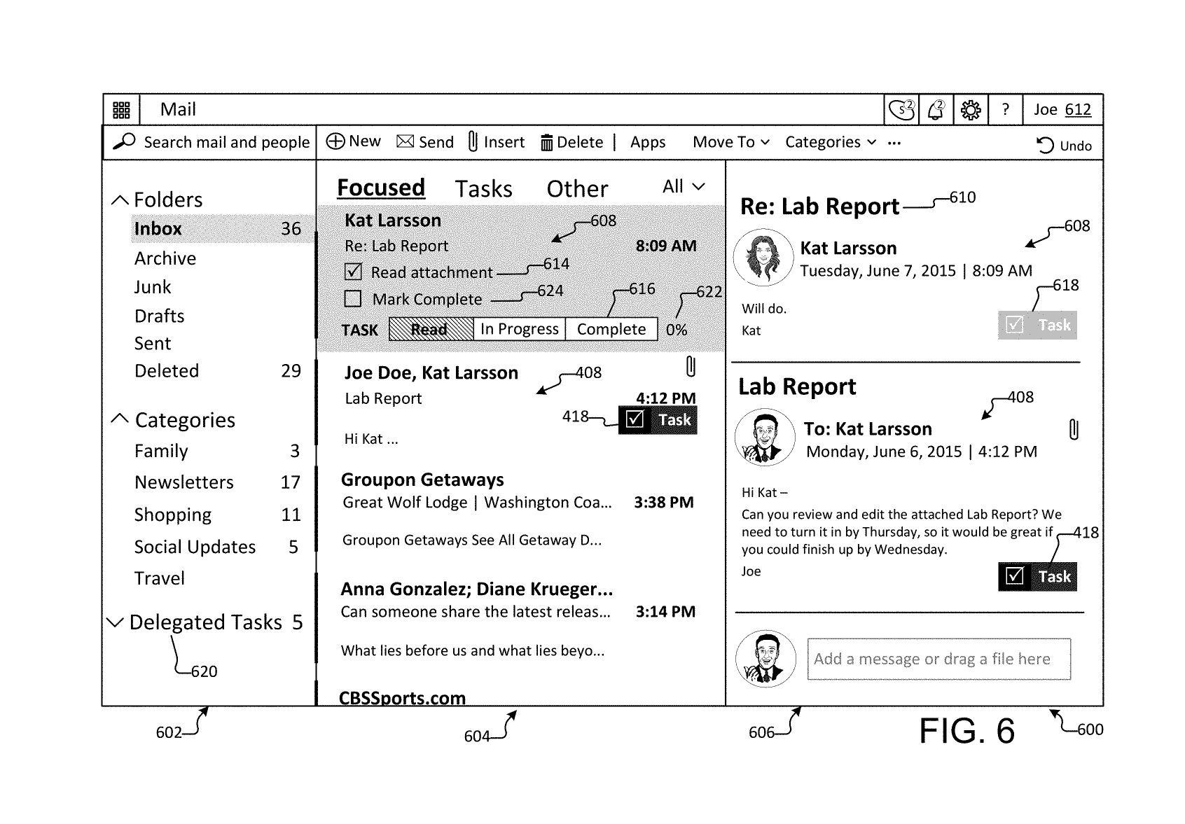

FIG. 6 illustrates an interface displaying a reply email and a progress bar for a delegated task, according to an example embodiment.

As illustrated, an interface 600 of a messaging application is provided. Interface 600 includes a navigation pane 602, a list pane 604, and a reading pane 606. As illustrated, email 408 associated with a delegated task (as evidenced by checked task control 418) was sent by Joe to recipient Kat Larsson at 4:12 PM on Jun. 6, 2015 (as evidenced in reading pane 606 and list pane 604). Additionally, Kat Larsson sent a reply email 608 at 8:09 AM on Jun. 7, 2015. The text of reply email 608 states “Will do.” Reply email 608 includes a reply subject line 610, entitled “Re: Lab Report.” In the case of reply email 608, a “task control” 618 is illustrated as checked but is not actionable (grayed out). In this way, reply email 608 is flagged as associated with a delegated task and the recipient is unable to “deselect” task control 618.

As further illustrated in list pane 604, a status of the delegated task has been provided. For instance, attachment status 614 is identified as “read” (as evidenced by a checked box). In this way, the sender “Joe” (see, e.g., user identifier 612) is able to readily see that the Lab Report attached to the email 408 had been opened by recipient Kat Larsson. Further, a progress bar 616 has been provided as a visual representation of the status of the delegated task. Progress bar 616 shows that the delegated task has been “Read” by the recipient Kat Larsson (as evidenced by hashed shading). The visual representation of the status of the delegated task further enables Joe to readily see that the recipient Kat Larsson has acknowledged the delegated task (as evidenced by the “Read” status on progress bar 616). A “% complete” indicator 622 shows that the delegated task is currently “0%” complete. However, should Joe learn that Kat Larsson has completed the task (e.g., via an offline communication or any other means), Joe may directly mark the task complete by selecting a mark complete control 624 (e.g., activating a check box, clicking a button, etc.). When Joe selects the mark complete control 624 (not shown), progress bar 616 may automatically be updated to show the delegated task as “Complete” (not shown) and the % complete indicator 622 may automatically be updated to show 100% (not shown). As further illustrated, the delegated tasks tab 620 has been updated to reflect “5” delegated tasks as compared to the delegated tasks tab 422, which showed “4” delegated tasks.

As should be appreciated, the various devices, components, etc., described with respect to FIG. 6 are not intended to limit the systems and methods to the particular components described. Accordingly, additional topology configurations may be used to practice the methods and systems herein and/or some components described may be excluded without departing from the methods and systems disclosed herein.

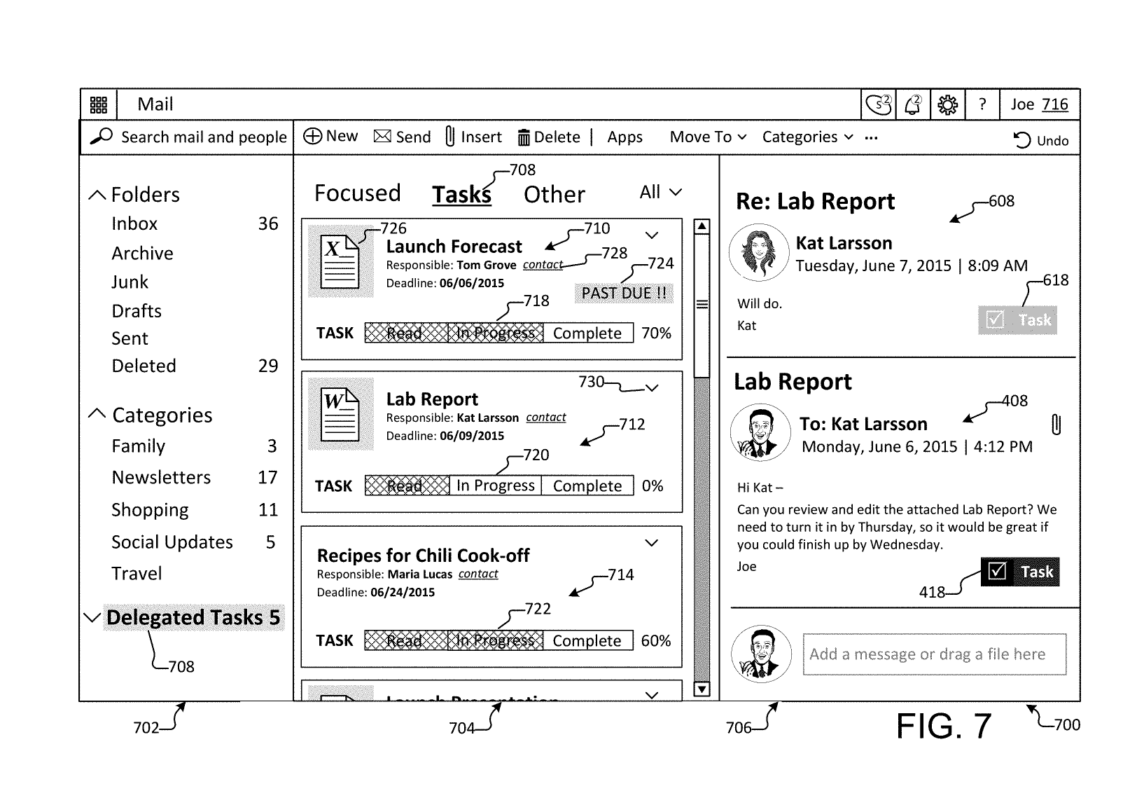

FIG. 7 illustrates an interface with a delegated tasks pane for tracking progress of a plurality of delegated tasks, according to an example embodiment.

As illustrated, an interface 700 of a messaging application is provided. Interface 700 includes a navigation pane 702, a list pane 704, and a reading pane 706. As illustrated, email 408 associated with a delegated task (as evidenced by checked task control 418) was sent by Joe to recipient Kat Larsson at 4:12 PM on Jun. 6, 2015 (as evidenced in reading pane 706). Additionally, Kat Larsson sent a reply email 608 related to the delegated task (as evidenced by checked task control 618) at 8:09 AM on Jun. 7, 2015 (as evidenced in reading pane 706).

As further illustrated by FIG. 7, delegated tasks tab 708 has been selected (as evidenced by shading) in navigation pane 702. In this case, a delegated tasks pane with a plurality of delegated tasks is provided in list pane 704, including delegated task 710, delegated task 712 and delegated task 714. In this example, delegated task 712 corresponds to the delegated task associated with email 408 and reply email 608, as described above. Delegated tasks 710-714 are listed in order of due date. For each delegated task, a visual representation of the progress of the delegated task is provided by a progress bar. Additionally, although not illustrated by list pane 704, each delegated task may include a “mark complete” control (e.g., similar to mark complete control 624) that is selectable by the delegator of the task (e.g., “Joe”) to directly mark any of the delegated tasks complete (e.g., in response to learning that the recipient has completed the delegated task via any communications means). As illustrated by list pane 704, delegated task 710 includes progress bar 718, which shows that delegated task 710 has been “read” and is “in progress” (as evidenced by hashed shading). As further indicated, delegated task 710 is “70%” complete. However, in the case of delegated task 710, the due date of Jun. 6, 2015 has already past (see, e.g., sent date for reply email 608). In this case, a passive notification 724 is provided, which states “PAST DUE!!”

As further illustrated, a document 726 is associated with delegated task 710. In this way, documents and other attachments associated with a delegated task may be accessed from a single location, e.g., the delegated tasks pan. The delegated tasks pane may also include one or more interactive elements. For instance, “contact” control 728 may be activated (or selected) in order to follow up with the recipient of delegated task 710 regarding the past-due deadline. Additionally, as illustrated by delegated task 712, an expand control 730 is provided. In aspects, expand control 730 enables additional information to be displayed for the delegated task. As should be appreciated, the delegated tasks pane enables a user (e.g., “Joe” as evidenced by user identifier 716) to view, interact with, and track a plurality of delegated tasks from a single user interface. In this way, management of a plurality of delegated tasks is facilitated for a sender/delegator.

As should be appreciated, the various devices, components, etc., described with respect to FIG. 7 are not intended to limit the systems and methods to the particular components described. Accordingly, additional topology configurations may be used to practice the methods and systems herein and/or some components described may be excluded without departing from the methods and systems disclosed herein.

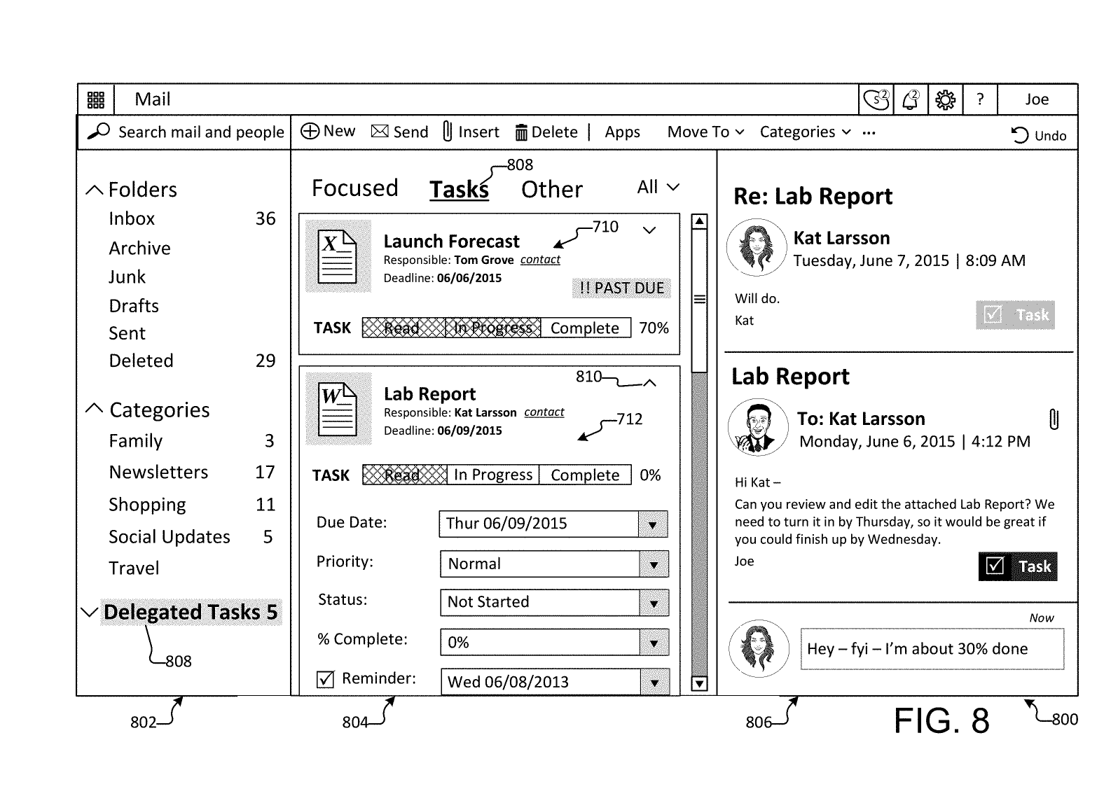

FIG. 8 illustrates an interface with a delegated tasks pane for updating parameters for a delegated task, according to an example embodiment.

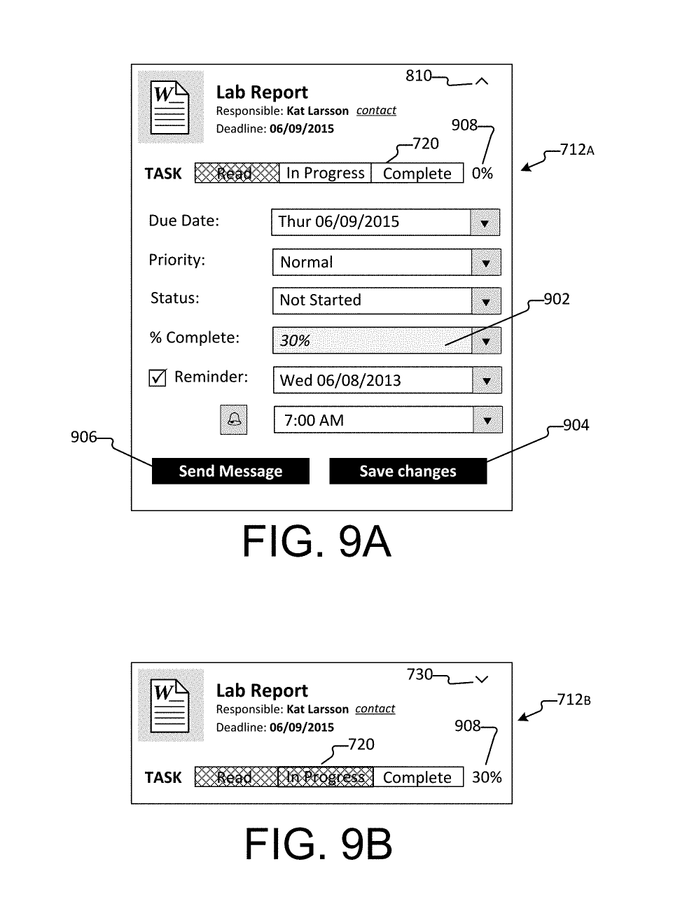

As illustrated, an interface 800 of a messaging application is provided. Interface 800 includes a navigation pane 802, a list pane 804, and a reading pane 806. As illustrated, delegated tasks tab 808 has been selected (as evidenced by shading) in navigation pane 802. Similar to interface 700 of FIG. 7, a delegated tasks pane with a plurality of delegated tasks is provided in list pane 804, including delegated task 710 and delegated task 712. In this case, expand control 730 (not shown) has been selected and collapse control 810 is provided. As shown, an expanded view for delegated task 712 displays additional information. For instance, as will be further described with reference to FIGS. 9A and 9B, one or more parameters for delegated task 712 are displayed. The one or more parameters include, for instance, a due date, a priority, a status and a % complete. Additionally, a check box control has been selected for a reminder and a reminder date has been input. In this way, parameters associated with a plurality of delegated tasks may be easily updated from a single user interface, facilitating tracking and management of delegated tasks.

As should be appreciated, the various devices, components, etc., described with respect to FIG. 8 are not intended to limit the systems and methods to the particular components described. Accordingly, additional topology configurations may be used to practice the methods and systems herein and/or some components described may be excluded without departing from the methods and systems disclosed herein.

FIGS. 9A and 9B illustrate an interface for updating one or more parameters of a delegated task, according to an example embodiment.

As illustrated, first and second views for delegated task 712 are provided. As noted above, delegated task 712 corresponds to the delegated task associated with email 408 and reply email 608. As illustrated by FIG. 9A, the first view 712A is an expanded view of delegated task 712, similar to the expanded view illustrated by FIG. 8. In this case, expand control 730 (not shown) has been selected and collapse control 810 is shown. The first view 712A provides progress information and inactive controls for updating and managing delegated task 712. For instance, progress bar 720 is provided, showing that delegated task 712 has been read and is 0% complete (as shown by % complete indicator 908). Additionally, first view 712A provides a “send message” control 906 for following up with the recipient of delegated task 712.

As shown, the first view 712A further provides interface elements (e.g., input fields, drop-down menus, etc.) for updating the one or more parameters associated with delegated task 712. For instance, parameters such as “Due Date,” “Priority,” “Status,” and “% Complete,” etc., may be updated from the expanded view of delegated task 712. As illustrated, input field 902 has been selected (as evidenced by shading) and a parameter value for the % complete parameter type has been updated to show “30%” complete. The 30% input is shown as italicized to indicate that it has not yet been saved. In response to selection of save control 904, the update to the % complete parameter type may be stored for delegated task 712.

As illustrated by FIG. 9B, second view 712B of delegated task 712 is provided. In this case, collapse control 810 (not shown) has been selected and expand control 730 is shown. Second view 712B shows that the update to the % complete parameter has been stored, as evidenced by % complete indicator 908, which shows 30% complete. Additionally, in response to storing the update to the % complete parameter type, the progress bar 720 has been automatically updated to show that delegated task 712 is “in progress.” As should be appreciated, second view 712B may be reflected in a delegated tasks pane such as illustrated by FIGS. 7 and 8.

As should be appreciated, the various devices, components, etc., described with respect to FIGS. 9A and 9B are not intended to limit the systems and methods to the particular components described. Accordingly, additional topology configurations may be used to practice the methods and systems herein and/or some components described may be excluded without departing from the methods and systems disclosed herein.

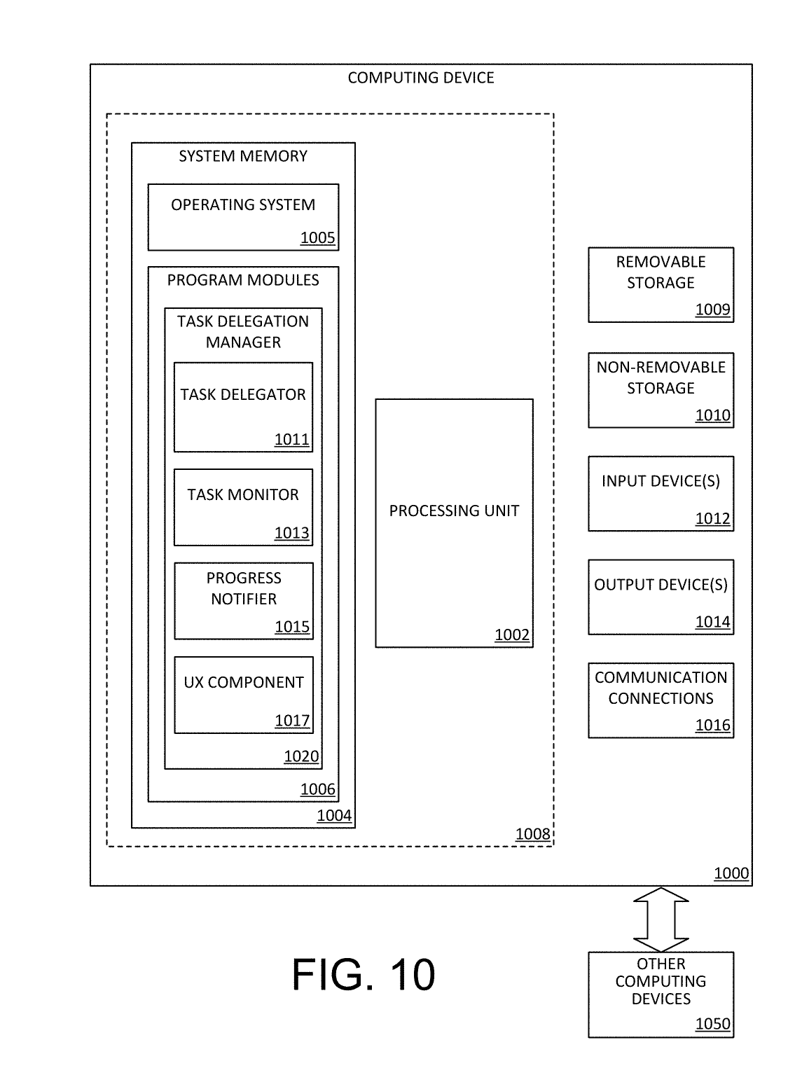

FIGS. 10-13 and the associated descriptions provide a discussion of a variety of operating environments in which aspects of the disclosure may be practiced. However, the devices and systems illustrated and discussed with respect to FIGS. 10-13 are for purposes of example and illustration and are not limiting of a vast number of computing device configurations that may be utilized for practicing aspects of the disclosure, as described herein.

FIG. 10 is a block diagram illustrating physical components (e.g., hardware) of a computing device 1000 with which aspects of the disclosure may be practiced. The computing device components described below may have computer executable instructions for implementing a task delegation manager 1020 on a computing device (e.g., server computing device 108 and/or client computing device 104), including computer executable instructions for task delegation manager 1020 that can be executed to implement the methods disclosed herein. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for running task delegation manager 1020, such as one or more components with regard to FIG. 1 and, in particular, task delegator 1011 (e.g., including message receiver/sender 112 and task delegator 114), task monitor 1013 (e.g., corresponding to task monitor 116), progress notifier 1015 (e.g., corresponding to progress notifier 118), and/or UX component 1017 (e.g., corresponding to UX component 120).

The operating system 1005, for example, may be suitable for controlling the operation of the computing device 1000. Furthermore, embodiments of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., task delegation manager 1020) may perform processes including, but not limited to, the aspects, as described herein. Other program modules that may be used in accordance with aspects of the present disclosure, and in particular for creating and managing delegated tasks assigned using a message, may include task delegator 1011, task monitor 1013, progress notifier 1015, and/or UX component 1017, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media may be non-transitory media that does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

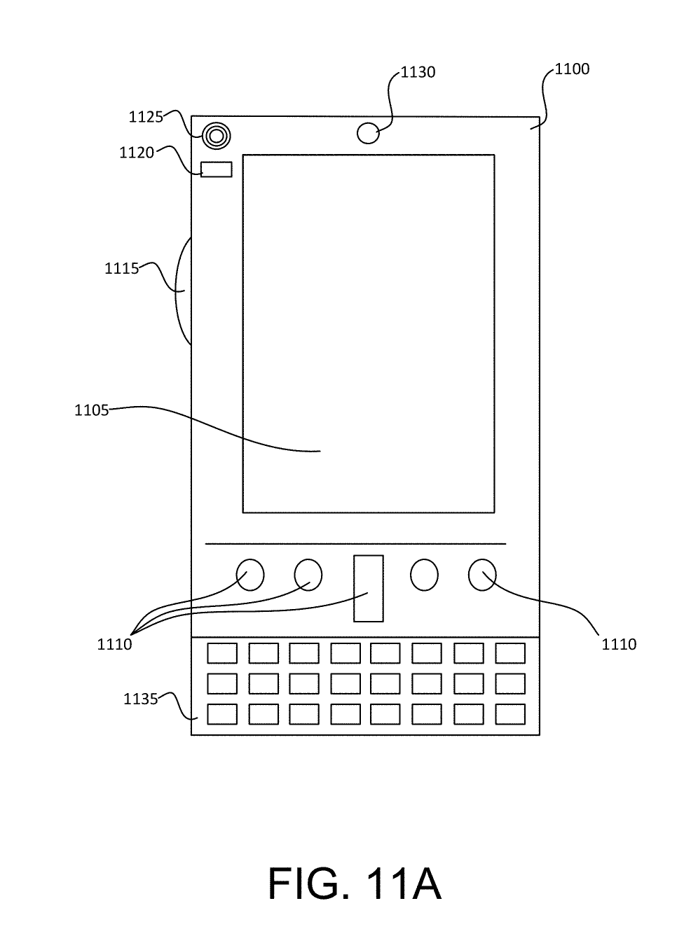

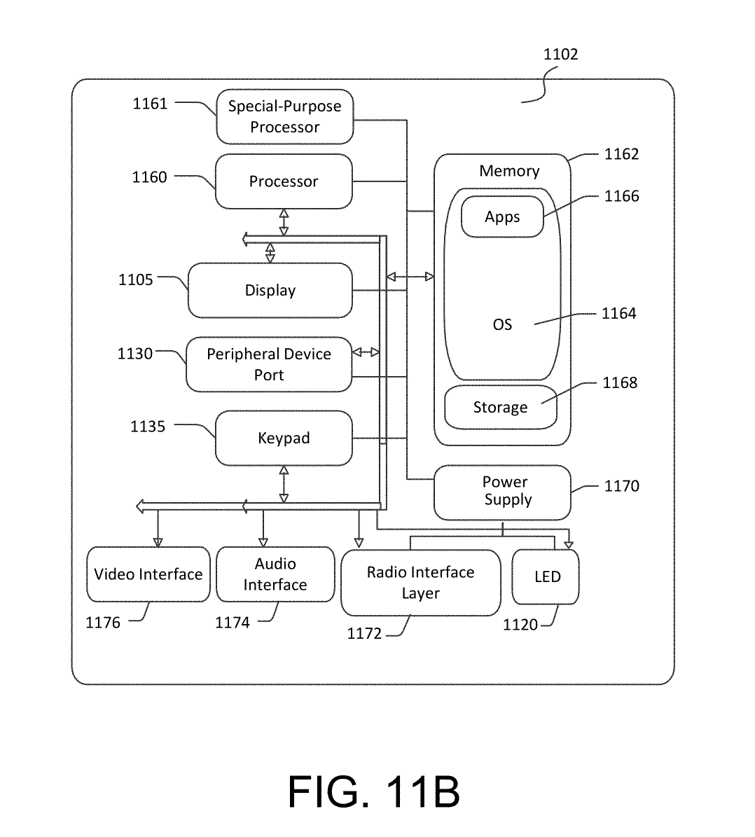

FIGS. 11A and 11B illustrate a mobile computing device 1100, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 11A, one aspect of a mobile computing device 1100 for implementing the aspects is illustrated. In a basic configuration, the mobile computing device 1100 is a handheld computer having both input elements and output elements. The mobile computing device 1100 typically includes a display 1105 and one or more input buttons 1110 that allow the user to enter information into the mobile computing device 1100. The display 1105 of the mobile computing device 1100 may also function as an input device (e.g., a touch screen display). If included, an optional side input element 1115 allows further user input. The side input element 1115 may be a rotary switch, a button, or any other type of manual input element. In alternative aspects, mobile computing device 1100 may incorporate more or less input elements. For example, the display 1105 may not be a touch screen in some embodiments. In yet another alternative embodiment, the mobile computing device 1100 is a portable phone system, such as a cellular phone. The mobile computing device 1100 may also include an optional keypad 1135. Optional keypad 1135 may be a physical keypad or a “soft” keypad generated on the touch screen display. In various embodiments, the output elements include the display 1105 for showing a graphical user interface (GUI), a visual indicator 1120 (e.g., a light emitting diode), and/or an audio transducer 1125 (e.g., a speaker). In some aspects, the mobile computing device 1100 incorporates a vibration transducer for providing the user with tactile feedback. In yet another aspect, the mobile computing device 1100 incorporates input and/or output ports, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one aspect of a mobile computing device. That is, the mobile computing device 1100 can incorporate a system (e.g., an architecture) 1102 to implement some aspects. In one embodiment, the system 1102 is implemented as a “smart phone” capable of running one or more applications (e.g., browser, e-mail, calendaring, contact managers, messaging clients, games, and media clients/players). In some aspects, the system 1102 is integrated as a computing device, such as an integrated personal digital assistant (PDA) and wireless phone.

One or more application programs 1166 may be loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 1166 may use and store information in the non-volatile storage area 1168, such as email or other messages used by an email application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100, including the instructions for creating and managing delegated tasks as described herein (e.g., message receiver/sender, task delegator, task monitor, progress notifier and/or UX component, etc.).

The system 1102 has a power supply 1170, which may be implemented as one or more batteries. The power supply 1170 may further include an external power source, such as an AC adapter or a powered docking cradle that supplements or recharges the batteries. The system 1102 may also include a radio interface layer 1172 that performs the function of transmitting and receiving radio frequency communications. The radio interface layer 1172 facilitates wireless connectivity between the system 1102 and the “outside world,” via a communications carrier or service provider. Transmissions to and from the radio interface layer 1172 are conducted under control of the operating system 1164. In other words, communications received by the radio interface layer 1172 may be disseminated to the application programs 1166 via the operating system 1164, and vice versa.

The visual indicator 1120 may be used to provide visual notifications, and/or an audio interface 1174 may be used for producing audible notifications via an audio transducer 1125 (e.g., audio transducer 1125 illustrated in FIG. 11A). In the illustrated embodiment, the visual indicator 1120 is a light emitting diode (LED) and the audio transducer 1125 may be a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the user takes action to indicate the powered-on status of the device. The audio interface 1174 is used to provide audible signals to and receive audible signals from the user. For example, in addition to being coupled to the audio transducer 1125, the audio interface 1174 may also be coupled to a microphone to receive audible input, such as to facilitate a telephone conversation. In accordance with embodiments of the present disclosure, the microphone may also serve as an audio sensor to facilitate control of notifications, as will be described below. The system 1102 may further include a video interface 1176 that enables an operation of peripheral device 1130 (e.g., on-board camera) to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11B by the non-volatile storage area 1168.

Data/information generated or captured by the mobile computing device 1100 and stored via the system 1102 may be stored locally on the mobile computing device 1100, as described above, or the data may be stored on any number of storage media that may be accessed by the device via the radio interface layer 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio interface layer 1172 or via a distributed computing network. Similarly, such data/information may be readily transferred between computing devices for storage and use according to well-known data/information transfer and storage means, including electronic mail and collaborative data/information sharing systems.

As should be appreciated, FIGS. 11A and 11B are described for purposes of illustrating the present methods and systems and are not intended to limit the disclosure to a particular sequence of steps or a particular combination of hardware or software components.

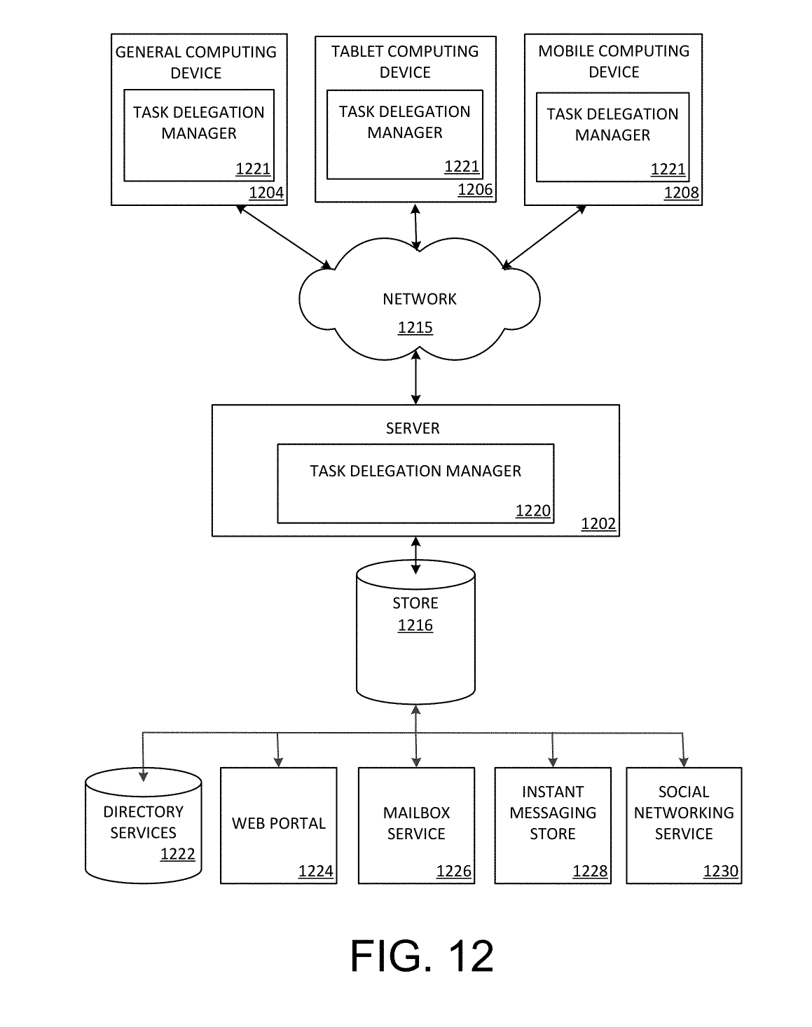

FIG. 12 illustrates one aspect of the architecture of a system for processing data received at a computing system from a remote source, such as a general computing device 1204 (e.g., personal computer), tablet computing device 1206, or mobile computing device 1208, as described above. Content displayed at server device 1202 may be stored in different communication channels or other storage types. For example, various documents may be stored using a directory service 1222, a web portal 1224, a mailbox service 1226, an instant messaging store 1228, or a social networking service 1230. The task delegation manager 1221 may be employed by a client that communicates with server device 1202, and/or the task delegation manager 1220 may be employed by server device 1202. The server device 1202 may provide data to and from a client computing device such as a general computing device 1204, a tablet computing device 1206 and/or a mobile computing device 1208 (e.g., a smart phone) through a network 1215. By way of example, the computer system described above with respect to FIGS. 1-11 may be embodied in a general computing device 1204 (e.g., personal computer), a tablet computing device 1206 and/or a mobile computing device 1208 (e.g., a smart phone). Any of these embodiments of the computing devices may obtain content from the store 1216, in addition to receiving graphical data useable to either be pre-processed at a graphic-originating system or post-processed at a receiving computing system.

As should be appreciated, FIG. 12 is described for purposes of illustrating the present methods and systems and is not intended to limit the disclosure to a particular sequence of steps or a particular combination of hardware or software components.

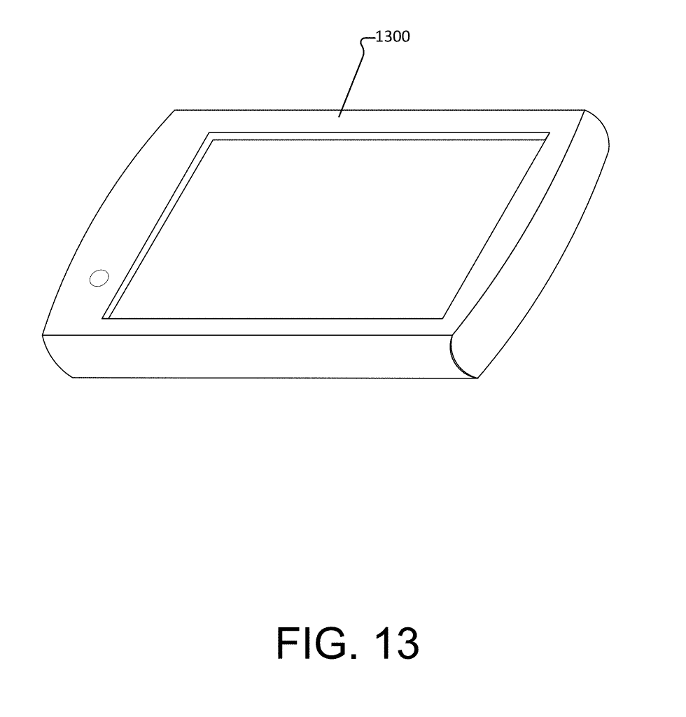

FIG. 13 illustrates an exemplary tablet computing device 1300 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 13 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer system comprising:
at least one processing unit; and
at least one memory storing computer executable instructions that, when executed by the at least one processing unit, cause the computer system to perform a method, the method comprising:
receiving a message from a sender;
determining that the message delegates a task;
identifying one or more parameters associated with the delegated task;
sending the message to a recipient;
monitoring a progress of the delegated task by the recipient; and
providing a status of the delegated task to the sender.

2. The computer system of claim 1, wherein monitoring the progress of the delegated task comprises receiving an indication from the recipient regarding the progress of the delegated task.

3. The computer system of claim 1, wherein monitoring the progress of the delegated task comprises monitoring one or more communications of the recipient.

4. The computer system of claim 1, wherein providing the status of the delegated task to the sender comprises a visual representation of the progress of the delegated task.

5. The computer system of claim 4, wherein the visual representation is a progress bar.

6. The computer system of claim 1, further comprising:
providing a delegated tasks interface for one or more delegated tasks.

7. The computer system of claim 6, wherein the delegated tasks interface comprises a progress bar for each of the one or more delegated tasks.

8. The computer system of claim 6, wherein the delegated tasks interface is provided in a pane of a messaging interface.

9. The computer system of claim 8, wherein the messaging interface is associated with one of: an email application, an instant messaging application, a message board, and a texting application.

10. The computer system of claim 1, wherein determining that the message delegates a task is based on an indication that the message delegates a task received from the sender.

11. The computer system of claim 1, wherein the indication that the message delegates a task is received in response to activation of a control.

12. A method for managing a delegated task performed by a computing device, the method comprising:
retrieving the delegated task;
monitoring a progress of the delegated task by a recipient;
determining whether at least one progress update has been received for the delegated task; and
providing a notification to the sender regarding the progress of the delegated task.

13. The method of claim 12, wherein monitoring the progress of the delegated task comprises receiving an indication from the recipient regarding the progress of the delegated task.

14. The method of claim 12, wherein monitoring the progress of the delegated task comprises monitoring one or more communications of the recipient.

15. The method of claim 12, wherein the notification to the sender comprises a visual representation of the progress of the delegated task.

16. The method of claim 15, wherein the visual representation is a progress bar.

17. The method of claim 12, further comprising:
providing a delegated tasks interface for one or more delegated tasks.

18. The method of claim 12, wherein the delegated tasks interface comprises a progress bar for each of the one or more delegated tasks.

19. A computer-readable storage medium storing computer executable instructions that, when executed by at least one processing unit, cause a computing device to:
receive a message from a sender;
determine that the message delegates a task;
identify one or more parameters associated with the delegated task;
send the message to a recipient;
monitor a progress of the delegated task by the recipient; and
provide a visual representation of the progress of the delegated task to the sender.

20. The computer-readable storage medium of claim 19, wherein the visual representation is a progress bar.
